(19) United States
(12) Patent Application Publication
(10) Pub. No.: US 2011/0028626 A1
(43) Pub. Date: Feb. 3, 2011

(54) FLAME RETARDANT HALOGENATED ARYL ETHER OLIGOMER COMPOSITIONS AND THEIR PRODUCTION

(75) Inventors: Larry D. Timberlake, West Lafayette, IN (US); Julie A. McKeown, West Lafayette, IN (US)

Correspondence Address: Chemtura Corporation, 199 Benson Road, Middlebury, CT, 06749, US

(73) Assignee: CHEMTURA CORPORATION, Middlebury, CT (US)

(21) Appl. No.: 12/533,602

(22) Filed: Jul. 31, 2009

(51) Int. Cl. C08K 5/06

(52) U.S. Cl. 524/370

(57) ABSTRACT

In a process for producing a flame retardant halogenated aryl ether oligomer composition, an aryl ether oligomer is combined with a liquid carrier having a boiling point lower than water to form a slurry or solution of the aryl ether oligomer in the carrier. A halogenating agent is included in the slurry or solution to form a reaction composition, which is reacted at a temperature between about 20° C. and about 80° C. to form a reaction product containing the desired halogenated aryl ether oligomer composition. Unreacted halogenating agent is removed from the reaction product and the reaction product is contacted with an aqueous medium at a temperature sufficient to drive off the liquid carrier and produce an aqueous slurry of the halogenated aryl ether oligomer composition. The desired halogenated aryl ether oligomer composition is then recovered from the aqueous slurry.

### FIELD

This invention relates to flame retardant halogenated aryl ether oligomer compositions and their production.

### BACKGROUND

Decabromodiphenyl oxide (deca) and decabromodiphenylethane (deca-DPE) are commercially available materials widely used to flame retard various polymer resin systems. The structure of these materials is as follows:

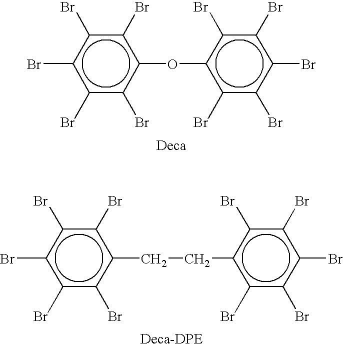

One of the advantages of using deca and deca-DPE in polymer resins that are difficult to flame retard, such as high-impact polystyrene (HIPS) and polyolefins, is that the materials have a very high (82-83%) bromine content. This allows a lower load level in the overall formulation, which in turn serves to minimize any negative effects of the flame retardant on the mechanical properties of the polymer.

Despite the commercial success of deca, there remains significant interest in developing alternative halogenated flame retardant materials that are equally or more efficient, not only because of economic pressures but also because they may allow lower flame retardant loadings, which in turn may impart improved performance properties. Improved properties, such as non-blooming formulations, or better mechanical properties can potentially be met by producing polymeric or oligomeric flame retardant compounds. These types of materials tend become entangled in the base resin polymer matrix, depending on the compatibility between the resin and the flame retardant, and hence should show fewer tendencies to bloom.

There are a number of commercially available flame retardant materials that can be considered oligomers or polymers of halogenated monomers. Examples of these monomers include tetrabromobisphenol A (TBBPA) and dibromostyrene (DBS), which have the following structures:

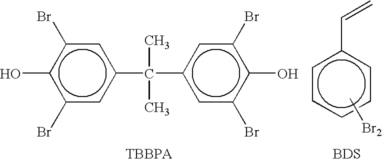

Commercially, TBBPA and DBS are typically not used in their monomeric form, but are converted into an oligomeric or polymeric species. One class of oligomers is the brominated carbonate oligomers based on TBBPA. These are commercially available from Chemtura Corporation (examples include Great Lakes BC-52™, Great Lakes BC-52HP™, and Great Lakes BC-58™) and by Teijin Chemical (FireGuard 7500 and FireGuard 8500). These products are used primarily as flame retardants for polycarbonate and polyesters.

Brominated epoxy oligomers, based on condensation of TBBPA and epichlorohydrin, are commercially available and sold by Dainippon Ink and Chemicals under the Epiclon® series, and also by ICL Industrial Products (examples are F-2016 and F-2100) and other suppliers. The brominated epoxy oligomers find use as flame retardants for various thermoplastics both alone and in blends with other flame retardants.

Another class of brominated polymeric flame retardants based on TBBPA is exemplified by Teijin FG-3000, a copolymer of TBBPA and 1,2-dibromoethane. This aralkyl ether finds use in ABS and other styrenic polymers. Alternative end-groups, such as aryl or methoxy, on this polymer are also known as exemplified by materials described in U.S. Pat. No. 4,258,175 and U.S. Pat. No. 5,530,044. The non-reactive end-groups are claimed to improve the thermal stability of the flame retardant.

TBBPA is also converted into many other different types of epoxy resin copolymer oligomers by chain-extension reactions with other difunctional epoxy resin compounds, for example, by reaction with the diglycidylether of bisphenol A. Typical examples of these types of epoxy resin products are D.E.R.™ 539 by the Dow Chemical Company, or Epon™ 828 by Hexion Corporation. These products are used mainly in the manufacture of printed circuit boards.

DBS is made for captive use by Chemtura Corporation and is sold as several different polymeric species (Great Lakes PDBS-80™, Great Lakes PBS-64HW™, and Firemaster CP44-HF™) to make poly(bromostyrene) type flame retardants. These materials represent homopolymers or copolymers. Additionally, similar brominated polystyrene type flame retardants are commercially available from Albemarle Chemical Corporation (Saytex® HP-3010, Saytex® HP-7010, and PyroChek 68PB). All these polymeric products are used to flame retard thermoplastics such as polyamides and polyesters.

Unfortunately, one of the key drawbacks of the existing halogenated polymer materials is their relatively low halogen content, which makes them less efficient as flame retardants and consequently typically has a negative effect on the desirable physical properties of the flame retardant formulations containing them, such as impact strength. For example, whereas deca and deca-DPE contain 82-83% bromine, oligomers or polymers based on the brominated monomers mentioned above generally have a bromine content in the range of 52%-68%, depending on the material. This therefore typically requires a flame retardant loading level in a polymer formulation significantly higher than that required for deca, often resulting in inferior mechanical properties for the formulation.

In our U.S. Patent Application Publication No. 2008/0269416, we have proposed a new class of flame retardant materials that to not detract from the mechanical properties of the target resin and that are based on halogenated aryl ether oligomers comprising the following repeating monomeric units:

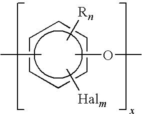

wherein R is hydrogen or alky, especially C₁ to C₄ alkyl, Hal is halogen, normally bromine, m is at least 1, n is 0 to 3 and x is at least 2, such as 3 to 100,000. The oligomer precursors are produced by oligomerization of a hydroxyhaloaryl material, such as bromophenol, or by reaction of a dihalo aryl material, such as dibromobenzene, with a dihydroxyaryl material, such as resorcinol, using an ether synthesis, such as the Ullmann ether synthesis. The resulting oligomers are brominated by adding dry bromine to a slurry of the oligomer with chloroform and an aluminum chloride catalyst held under reflux. These materials can be halogenated to a higher level than other currently available oligomeric flame retardants and provide superior mechanical properties when combined with resins such as HIPS and polyolefins as well as engineering thermoplastics such as polyamides and polyesters. It is also found that these aryl ether oligomers, even at lower levels of halogenation, give formulations with acceptable mechanical properties.

The materials disclosed in the '416 publication are polymeric in the sense that they have a molecular weight distribution resulting from the varying degrees of polymerization of the monomer units. In contrast, other known flame retardants are based on discrete halogenated phenyl ether compounds, which have multiple phenyloxy linkages but which are not polymeric in the sense that they do not have a molecular weight distribution. For example, Japanese Unexamined Patent Application Publication 2-129,137 discloses flame retardant polymer compositions in which the polymer is compounded with a halogenated bis(4-phenoxyphenyl)ether shown by general formula [I]:

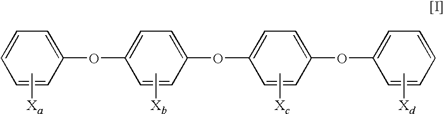

in which X is a halogen atom, a and d are numbers in the range of 1-5, and b and c are numbers in the range of 1-4. The bis(4-phenoxyphenyl)ether precursor is a discrete compound with no oligomeric distribution and the flame retardant is produced by reacting a solution of the precursor in 1,2-dichloroethane (EDC) with a bromine/EDC solution containing an aluminum chloride catalyst. After the reaction is complete, water is added and excess bromine and EDC are distilled off, leaving an aquous slurry from which the desired product can be isolated by filtration and drying

U.S. Pat. No. 3,760,003 discloses halogenated polyphenyl ether flame retardants having the general formula:

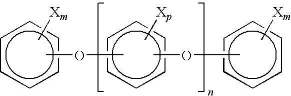

wherein each X is independently Cl or Br, each m is independently an integer of 0 to 5, each p is independently an integer of 0 to 4, n is an integer of 2 to 4, and 50% or more by weight of the compound is halogen. The ether precursors again appear to be discrete non-polymeric materials and are halogenated by reaction with bromine in the presence of iron powder as a catalyst and optionally methylene bromide. After the reaction is complete, the excess bromine is flash vaporized, leaving behind the desired solid product.

In an article entitled “Synthesis and Stationary Phase Properties of Bromo Phenyl Ethers, Journal of Chromatography, 267 (1983), pages 293-301, Dhanesar et al disclose a process for the site-specific bromination of phenyl ethers containing from 2 to 7 benzene rings. The ethers appear to be discrete compounds with no oligomeric distribution and bromination is effected by adding a solution of bromine in carbon tetrachloride dropwise to a dilute solution of the specific ether compound in carbon tetrachloride also containing a thallium acetate sesquihydrate catalyst. The mixture is then heated to reflux and, after the reaction is complete, the mixture is cooled and poured into a sodium bicarbonate solution. The organic phase is separated from the resultant mixture, washed with a sodium bicarbonate solution, and stripped of solvent to leave a viscous residue of the desired product.

In our co-pending U.S. Provisional Patent Application No. 61/139,282, filed Dec. 19, 2008, we have described a flame retardant blend comprising at least first and second halogenated phenyl ethers having the general formula (I):

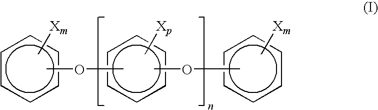

wherein each X is independently Cl or Br, each m is independently an integer of 1 to 5, each p is independently an integer of 1 to 4, n is an integer of 1 to 5 and wherein the values of n for the first and second ethers are different. Bromination is conveniently effected by adding bromine to a solution of the blended ether precursors in dichloromethane also containing an aluminum chloride catalyst. The reaction temperature is kept at 30° C. and the HBr off-gas is captured in a water trap. After the HBr evolution subsides, the material is worked up to give the product as an off-white solid.

WO2008/156928 discloses optoelectronic polymer compositions made from brominated polyarylethers having pendant carbazolyl groups. Useful polyarylethers are made by nucleophilic displacement condensation reactions between bisphenols and dihalogenated monomers. The resultant polyarylethers are then subjected to electrophilic aromatic substitution with bromine followed by nucleophilic aromatic substitution with a carbazole compound. Bromine substitution is typically effected by adding bromine dropwise to a solution of the ether in chloroform followed by precipitation with methanol.

The present invention seeks to provide a simple and efficient method for halogenating aryl ether oligomers so as to produce halogenated aryl ether oligomer compositions suitable for incorporation into polymer resins for imparting flame retardancy.

### SUMMARY

In one aspect, the invention resides in a process for producing a flame retardant halogenated aryl ether oligomer composition, the process comprising:
(a) combining an aryl ether oligomer with a liquid carrier having a boiling point lower than water to form a slurry or solution of said aryl ether oligomer in said carrier;
(b) including a halogenating agent in said slurry or solution to form a reaction composition;
(c) reacting said reaction composition at a temperature between about 20° C. and about 80° C. to form a reaction product comprising the desired halogenated aryl ether oligomer;
(d) removing unreacted halogenating agent from the reaction product;
(e) contacting the reaction product with an aqueous medium at an elevated temperature sufficient to drive off the liquid carrier and produce an aqueous slurry of said halogenated aryl ether oligomer; and
(f) recovering the halogenated aryl ether oligomer from said aqueous slurry.

In one embodiment, said aryl ether oligomer comprises repeating monomeric units of the formula (I):

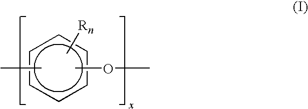

wherein R is alkyl, especially C₁ to C₄ alkyl, n is 0 to 3 and x is at least 2, such as 3 to 100,000.

In another embodiment, said aryl ether oligomer comprises a mixture of oligomeric compounds having the following formula (II):

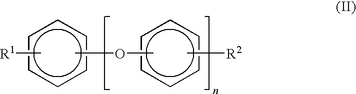

wherein n is 0 or at least 1; where R¹ is H, OH or halogen; and where R² is H, OH, halogen or a phenoxy group of the formula (III):

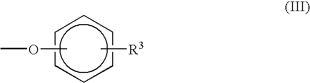

wherein R³ is OH or halogen;
wherein said oligomeric mixture comprises compounds of formula (II) with three benzene rings and compounds of formula (II) with more than three benzene rings;
wherein the average molecular weight of the compounds of formula (II) is at least 400; and
wherein the compounds of formula (II) comprise, on average, from 2 wt % to 35 wt % halogen.

Conveniently, said oligomeric mixture comprises less than 30 wt % of compounds of formula (II) with two benzene rings and less than 1 wt % of compounds of formula (II) with one benzene ring.

Conveniently, said oligomeric mixture has a weight average molecular weight (Mw) of about 600 to about 2000 and a polydispersity of about 1.4 to about 2.5 as measured by GPC chromatography versus a polystyrene standard.

Conveniently, said oligomeric mixture is produced by reacting a dihalobenzene with at least one dihydroxybenzene, preferably with the dihalobenzene being in molar excess.

Conveniently, said liquid carrier is selected from methylene chloride, chloroform, dibromomethane, 1,2-dichloroethane and bromochloromethane. Alternatively, bromine comprises the solvent and the halogenating agent.

Conveniently, the unreacted bromine is removed by distillation in (d).

Conveniently, wherein aqueous medium is water or a dilute acid solution.

Conveniently, (e) is effected by adding water to the reaction product to form an aqueous product mixture and then raising the temperature of said mixture. Alternatively, (e) is effected by adding said reaction product to water at a temperature between 70-100° C. to flash off said solvent.

Conveniently, at least part of said reacting (b) is conducted in the presence of a Lewis acid catalyst, such as aluminum chloride.

In a further aspect, the invention resides in a flame retardant halogenated aryl ether oligomer composition comprising a mixture of oligomeric compounds having the following formula (IV):

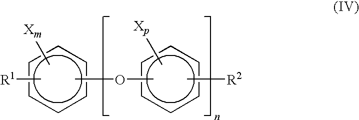

wherein n is 0 or at least 1; where R¹ is H, OH or halogen; X is halogen, each of m and p is at least 1, and where R² is H, OH, halogen or a phenoxy group of the formula (V):

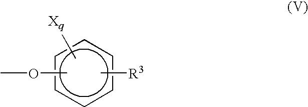

wherein R³ is OH or halogen and q is at least 1;
wherein said oligomeric mixture comprises compounds of formula (IV) with three benzene rings and compounds of formula (IV) with more than three benzene rings;
wherein the average molecular weight of the compounds of formula (IV) is at least 1000; and
wherein the compounds of formula (IV) comprise, on average, from 55 wt % to 82 wt % halogen.

### DETAILED DESCRIPTION OF THE EMBODIMENTS

Described herein is a method of halogenating, and in particular a method of brominating, aryl ether oligomer mixtures and flame retardant halogenated aryl ether oligomer compositions produced by such a method.

The term “oligomer” is used herein to mean a compound formed by oligomerization of one or more monomers so as to have repeating units derived from said monomer(s) irrespective of the number of said repeating units. The oligomers will have a distribution of molecular weight.

### Aryl Ether Oligomer Precursor

Although the present bromination process can be used with any aryl ether oligomer mixture, the process is particularly intended for use with an oligomer mixture comprising repeating monomeric units of the formula (I):

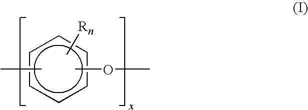

wherein R is alkyl, especially C₁ to C₄ alkyl, n is 0 to 3 and x is at least 2, such as 3 to 100,000.

More particularly, the aryl ether precursor employed herein comprises a mixture of oligomeric compounds formed by reacting a dihalobenzene, normally dibromobenzene, with a dihydroxybenzene and having the formula (II):

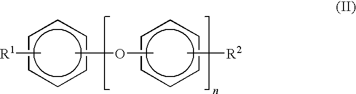

wherein n is 0 or at least 1; where R¹ is H, OH or halogen; and where R² is H, OH, halogen or a phenoxy group of the formula (III):

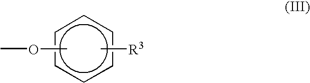

wherein R³ is OH or halogen;
wherein said oligomeric mixture comprises compounds of formula (II) with three benzene rings and compounds of formula (II) with more than three benzene rings;

wherein the average molecular weight of the compounds of formula (II) is at least 400; and

wherein the compounds of formula (II) comprise, on average, from 2 wt % to 35 wt %, such as from 5 wt % to 30 wt %, for example, from 10 wt % to 25 wt %, halogen.

The oligomeric mixture of formula (II) formed by reacting a dihalobenzene with a dihydroxybenzene may have a weight average molecular weight (Mw) of about 600 to about 2000 and a polydispersity of about 1.4 to about 2.5 as measured by GPC chromatography versus a polystyrene standard.

The oligomeric mixture of formula (II) may have a limited amount of light ends, that is, a relatively small amount of unreacted monomers and dimers (i.e. compounds with two benzene rings). For example, the aryl composition of formula (II) may comprise 30 wt % or less, e.g., 20 wt % or less, e.g., 10 wt % or less, of compounds with one benzene ring and/or two benzene rings. Unreacted monomers may be present in the product mixture at a concentration of, for example, less than 1% by weight, of the entire aryl composition. Optionally, the unreacted monomers (e.g., dibromobenzene or dihydroxybenzene, which are compounds with only a single benzene ring) may be removed from the reaction product altogether or at least to a concentration of less than 0.1% by weight of the entire aryl composition, by a separation technique, such as distillation. Species of monomers and oligomers, especially dimers, which contain hydroxyl groups can also be removed by washing a reaction product with an aqueous base, such as NaOH, followed by washing the product with water. Especially after such washing treatment, the resulting aryl composition of formula (II) may comprise less than 2% by weight of compounds with two or less benzene rings. Recovered unreacted monomers and recovered dimers may be recycled and fed into the oligomerization reactor along with fresh reactant feed.

The oligomeric mixture of formula (II) may have a relatively large amount of medium and heavy ends, that is, compounds having 3 or more benzene rings. Such medium and heavy ends may comprise 80 wt % or greater of compounds of formula (II). However, the heavy ends of this mixture may be restricted. For example, the reaction product formed by reacting dibromobenzene with a dihydroxybenzene may have less than 80 wt % of compounds of formula (II) with five or more benzene rings.

The compounds of formula (II) may have terminal halogen substituents and terminal hydroxyl substituents. There may be more terminal halogen substituents, i.e. compounds where R₁, R₂ or R₃ in formula (II) are halogen, than terminal hydroxyl substituents, i.e. compounds where R₁, R₂ or R₃ in formula (II) are OH. Such compounds with an excess of halogen groups relative to OH groups may be made by reacting a molar excess of dihalobenzene with a molar deficiency of dihydroxybenzene (e.g., resorcinol). For example, such compounds may be formed when the molar ratio of dihalobenzene to dihydroxybenzene (e.g., resorcinol) in an appropriate reaction mixture for combining such compounds is from about 1.1:1 to about 1.9:1, e.g., from about 1.1:1 to about 1.6:1.

It is possible that a small quantity of unintended products, for example, 1 percent by weight or less, may result from side reactions. Such side reactions may result in small amounts of oligomers lacking a terminal OH or halo group (e.g., compounds of formula (II) where R₂ or R₃ is hydrogen), or where internal phenylene groups are directly connected to form a biphenyl linkage. It is also possible that a small amount of cyclic oligomeric products are produced in addition to the main linear molecules described by formula (II).

Particularly when resorcinol (i.e. 1,3-dihydroxybenzene) is used as a reactant, the compounds of formula (II) may have meta phenylene groups in the oligomers.

### Production of Aryl Ether Precursor

As indicated above, the aryl ether oligomer precursor employed herein is conveniently produced by reacting a dihalobenzene, normally dibromobenzene, with a dihydroxybenzene, especially resorcinol. In order to facilitate the reaction, a catalyst and a base are typically used. The base is capable of displacing protons from acidic phenol groups (i.e. hydroxyl groups) on dihydroxybenzenes. The displaced protons may be substituted with cations, particularly monovalent cations, from the base to form a salt. An example of a particular base is potassium hydroxide. Preferably, the dihydroxybenzene is converted into a salt prior to introducing the catalyst into the reaction mixture. The salts of dihydroxybenzene may be mono-salts (i.e. compounds having one terminal monovalent cation and one terminal hydroxyl group) or di-salts (i.e. compounds having two terminal monovalent cations and no terminal hydroxyl groups) or mixtures of mono-salts and di-salts.

The dihalobenzene and dihydroxybenzene used to form oligomers may be individual isomers of these compounds or mixtures thereof. For example, the isomers of dibromobenzene are 1,2-dibromobenzene, 1,3-dibromobenzene and 1,4-dibromobenzene. The isomers of dihydroxybenzene are 1,2-dihydroxybenzene, 1,3-dihydroxybenzene and 1,4-dihydroxybenzene. An example of a mixture of dibromobenzene isomers is a mixture of 1,2-, 1,3- and 1,4-dibromobenzene in a weight or molar ratio of 10:45:45.

The total number of moles of dihalobenzene used in the reaction may exceed the total number of moles of dihydroxybenzene. The use of such a molar excess of dihalobenzene promotes the formation of oligomers with more terminal halogen groups than terminal hydroxyl groups. The molar ratio of dihalobenzene (including mixtures of dihalobenzene isomers) to the molar ratio of dihydroxybenzene (including mixtures of dihydroxybenzene isomers) may be from about 1.1: to about 1.9:1, for example, from about 1.1:1 to about 1.6:1. In calculating these ratios, it will be understood that the dihydroxybenzenes may be in a protonated form, e.g., prior to contact with a base, or in a salt form, which is formed after contact with a base. Compositions which can be used as a base to form a salt of a dihydroxybenzene include KOH, NaOH, K₂CO₃, Cs₂CO₃ and K₃PO₄. These base compositions may be added to the reaction mixture in the form of a solution, such as an aqueous solution, or in the form of a solid.

A salt of dihydroxybenzene may be prepared by forming a mixture of dihydroxybenzene, an aqueous solution of a base and a solvent. This mixture may also include dihalobenzene and/or a liquid capable of forming an azeotrope with water. This mixture may then be heated to reflux to azeotropically remove water. The liquid capable of forming an azeotrope with water may be toluene. The solvent may be dimethylformamide. The number of monovalent cations in the base to the number of protons in hydroxyl groups of the dihydroxybenzene may be from about 0.9:1 to about 1.25:1. For example, when KOH is used as the base, the molar ratio of KOH to dihydroxybenzene may be from about 1.8:1 to about 2.5:1, for example, from about 2.1:1 to about 2.5:1. At least 50% of the liquid capable of forming an azeotrope may be stripped from the reaction mixture along with the water which is azeotropically removed. Optionally, the liquid capable of forming an azeotrope with water may be omitted, and water may be distilled out of the reaction directly. The dihalobenzene and dihydroxybenzene reactants may be added to the reaction mixture all at once or in stages. As an example of a staged addition, a first portion of the dihalobenzene reactant may be added to the reaction mixture initially, oligomers may be formed, and then the final portion of the dihalobenzene may be added to the reaction mixture.

The catalyst used in the reaction to form compounds of formula (II) may be a copper containing catalyst. Examples of such copper containing catalysts include copper (I) compounds (i.e. cuprous compounds) and copper (II) compounds (i.e. cupric compounds). These compounds may be oxides or salts. Particular examples of copper containing catalysts include Cul, CuBr, Cu₂O, CuO and cupric acetate. The molar ratio of copper containing catalyst to the dihydroxybenzene (whether in the protonated form or in the form of a salt) may be, for example, from about 0.01:1 to about 0.04:1.

The copper containing catalyst may be incorporated into the reaction mixture at any convenient stage. For example, the copper containing catalyst may be added to the reaction mixture after water has been removed, for example, by azeotropic stripping as described above. Optionally, the copper containing catalyst may be added to the reaction mixture before water removal.

The copper containing catalyst may optionally be combined with a ligand to promote the formation of oligomers of formula (II). Examples of such ligands include 1,10-phenanthroline, dimethylglycine, 1-butylimidazole, 1-methylimidazole and DL-alanine. The molar ratio of copper containing catalyst to ligand may be from 1:3 to about 3:1.

The reaction mixture including dibromobenzene, dihydroxybenzene (optionally in the form of a salt) and catalyst may be reacted to form oligomers of formula (II) under conditions including a temperature of about 140° C. to about 200° C., preferably about 150° C. to about 160° C., and a time of about 4 to about 20 hours, preferably about 6 to about 10 hours.

The product of the reaction may be recovered by any convenient means. For example, when a potassium salt of a dihydroxybenzene is used as a reactant a byproduct of the reaction is KBr. This KBr salt may be removed from the product mixture by filtration. The solvent may then be stripped from the reaction mixture to form an organic residue. The residue may be dissolved in a water-immiscible solvent if needed. This organic residue may then be washed with dilute aqueous base, such as NaOH or KOH, followed by water washing to remove any free phenolic-terminated oligomeric chains. This wash stream may be recycled back into a subsequent reaction to improve the yield. Optionally, the reaction mixture may be terminated by addition of an aryl halide such as bromobenzene toward the end of the reaction hold period to help to minimize the amount of free phenolic-terminated oligomer chains. Finally, residual dibromobenzene and/or bromobenzene and resorcinol low-boiling materials may be removed from the washed organic residue by distillation. Reactive materials recovered by distillation may be recycled back into a reaction mixture as appropriate.

### Halogenation of Aryl Ether Oligomer Precursor

In order to produce the final flame retardant composition, the aryl ether oligomer mixture as described above is halogenated, more typically is brominated. This is achieved by initially dissolving or dispersing the oligomer mixture in a liquid carrier, normally an organic medium, having a boiling point lower than water to form an aryl ether oligomer slurry or solution. Suitable liquid carriers include methylene chloride (boiling point 40° C.), chloroform (boiling point 61° C.), dibromomethane (boiling point 97° C.), 1,2-dichloroethane (boiling point 84° C.) and bromochloromethane (boiling point 68° C.).

A halogenating agent, typically bromine, is then added to the aryl ether oligomer slurry/solution to form a reaction composition which is then reacted at a temperature between about 20° C. and about 80° C. to form a reaction product containing the desired halogenated aryl ether oligomer, the solvent and unreacted halogenating agent. The reaction is complete when the release of hydrogen halide from the reaction composition ceases, typically after about 2 to about 4 hours. The released hydrogen halide is removed in a scrubber.

In one embodiment, bromine (boiling point 59° C.) is used as the liquid carrier for the oligomer precursor mixture and as the halogenating agent.

Generally a Lewis acid catalyst, such as aluminum chloride, is added to the reaction composition to facilitate the halogenation reaction. This can be achieved by adding the catalyst to the aryl ether slurry/solution prior to addition of the halogenating agent, by combining the catalyst with the halogenating agent and adding the combination to the aryl ether slurry/solution or by adding the catalyst to the reaction composition either at the beginning of the halogenation reaction or part of the way through the reaction, for example when initial liberation of hydrogen halide starts to slow down.

When the halogenation reaction is complete, any unreacted halogenating agent is removed from the reaction product, generally by distillation. Thereafter the product may be neutralized with a reducing agent capable of reacting with any residual free halogen that may still be present in the product. Suitable reducing agents include aqueous hydrazine and aqueous sodium bisulfite.

After removal of the unreacted halogenating agent, the reaction product is contacted with water at a temperature sufficient to strip out the initial liquid carrier and produce an aqueous slurry of the halogenated aryl ether oligomer composition. Alternatively, and particularly where bromine is used as the liquid carrier, the water stripping step can be used to drive off the liquid carrier and remove the unreacted halogenating agent in a single operation.

In one embodiment, stripping of the liquid carrier is achieved by adding water, or water containing dilute acid, to the reaction product and heating the mixture to at least the boiling point of the liquid carrier. Alternatively, the reaction product can be added to a separate vessel containing water, or water containing dilute acid, which has already been heated to 75 to 100° C. so that the liquid carrier is flashed from the product, leaving a slurry of the halogenated aryl ether oligomer composition in water.

Conveniently, the water used to strip out the liquid carrier contains a dilute (such as about 1 wt % to about 5 wt %), mineral acid, such as hydrochloric acid, so as to assist in removing residual Lewis acid catalyst.

After removal of the liquid carrier, the halogenated aryl ether oligomer composition can be recovered from the aqueous slurry by filtration and drying.

In one embodiment the resultant flame retardant halogenated aryl ether oligomer composition comprises a mixture of oligomeric compounds having the following formula (IV):

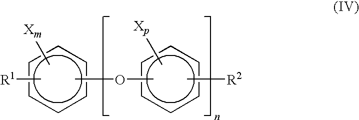

wherein n is 0 or at least 1; where R¹ is H, OH or halogen; X is halogen, each of m and p is at least 1, and where R is H, OH, halogen or a phenoxy group of the formula (V):

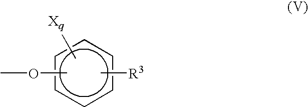

wherein R³ is OH or halogen and q is at least 1;
wherein said oligomeric mixture comprises compounds of formula (IV) with three benzene rings and compounds of formula (IV) with more than three benzene rings;
wherein the average molecular weight of the compounds of formula (IV) is at least 1000; and
wherein the compounds of formula (IV) comprise, on average, from 55 wt % to 82 wt %, especially from 65 wt % to 82 wt %, halogen.

### Use of the Halo Enated Aryl Ether Oligomer Composition

The resultant halogenated aryl ether oligomer composition can be used as a flame retardant for many different polymer resin systems because of its high thermal stability and also because of its relatively high halogen content compared with existing polymeric flame retardant products, such as brominated polystyrenes. Generally, the halogenated aryl ether oligomer composition is employed as a flame retardant with olefinic polymers, such as polyolefins, polystyrene, high-impact polystyrene (HIPS), and poly (acrylonitrile butadiene styrene) (ABS), polycarbonates (PC), PC-ABS blends, polyesters and/or polyamides. With such polymers, the level of the halogenated oligomer in the polymer formulation required to give a V-0 classification when subjected to the flammability test protocol from Underwriters Laboratories is generally within the following ranges:

| Polymer | Useful | Preferred |
|---|---|---|
| Polystyrene | 5 to 25 wt % | 10 to 20 wt % |
| Polypropylene | 20 to 50 wt % | 25 to 40 wt % |
| Polyethylene | 5 to 35 wt % | 20 to 30 wt % |
| Polyamide | 5 to 25 wt % | 10 to 20 wt % |
| Polyester | 5 to 25 wt % | 10 to 20 wt %. |

The present halogenated aryl ether oligomer can also be used with thermosetting polymers, such as an epoxy resins, unsaturated polyesters, polyurethanes and/or rubbers. Where the base polymer is a thermosetting polymer, a suitable flammability-reducing amount of the oligomer is between about 5 wt % and about 35 wt %, such as between about 10 wt % and about 25 wt %.

Typical applications for polymer formulations containing the present halogenated aryl ether oligomer as a flame retardant include automotive molded components, adhesives and sealants, fabric back coatings, electrical wire and cable jacketing, and electrical and electronic housings, components and connectors. In the area of building and construction, typical uses for the present flame retardant include self extinguishing polyfilms, wire jacketing for wire and cable, backcoating in carpeting and fabric including wall treatments, wood and other natural fiber-filled structural components, roofing materials including roofing membranes, roofing composite materials, and adhesives used to in construction of composite materials. In general consumer products the present flame retardant can be used in formulation of appliance parts, housings and components for both attended and unattended appliances where flammability requirements demand.

The invention will now be more particularly described with reference to the following Examples.

### Example 1

### Production of Aryl Ether Oligomer Mixture

An aryl ether oligomer mixture was prepared by reaction of resorcinol and dibromobenzene according to the following reaction protocol.

Resorcinol (1.0 Eq) and para-dibromobenzene (1.55 Eq) were charged to a reaction flask under nitrogen. Dimethylformamide (DMF) in an amount of 12.6 g DMF/g resorcinol was used as the solvent. Toluene (3 g/g resorcinol) was added to the flask followed by an aqueous solution of potassium hydroxide (2.25 mol KOH/mol resorcinol). After an initial exotherm, the reaction mixture was heated to reflux to azeotropically remove the water. Then, the toluene was removed by continued distillation until the reflux temperature of DMF was reached (153° C.). Anhydrous DMF was added back to the reaction flask if necessary to supplant some DMF that was distilled during the toluene strip to achieve 9.0 g DMF/g resorcinol ratio. Then, CuO (0.02 Eq) and dimethylglycine (0.03 Eq) were added to the flask and the reaction mixture was held at reflux for 8 hr. A sample was removed and isolated by methylene chloride/5% HCl washing. The organic layer of the washed sample was analyzed by HPLC and was found to consist of 2.2 wt % of material having less than or equal to 2 phenyl rings and 97.8 wt % of material having 2 or more phenyl rings.

### Example 2

### Bromination of Aryl Ether Oligomer Mixture of Example 1

A 1000 mL reaction flask was equipped with mechanical stirring, heating mantle, thermometer, bromine addition funnel and condenser with a gas outlet connected to a water trap. The flask was charged with 86.4 g aryl ether oligomer mixture from Example 1 and 576 mL methylene chloride to form a solution. Next, 8.64 g AlCl₃ was added to the flask. The bromine (578.3 g) was slowly added via the addition funnel over 2 hr at a temperature range of 25-30° C. The HBr evolved from the reaction was collected in the water trap. The reaction mixture was held at reflux (40-44° C.) for 3 hr until HBr evolution ceased. The reaction excess bromine was neutralized with 25 mL of 35% hydrazine in water. The resulting slurry was then pumped into a second reaction flask containing 90° C. water and solvent was flashed off, leaving behind a water slurry of the product. The slurry was filtered and the cake was washed with water and dried in an oven to give 337 g of product. Analysis: 77.4% organic bromine; 201-262° C. melt range; 179° C. Tg by DSC; 387° C. 5% wt loss by TGA.

### Example 3

### Bromination of Aryl Ether Oligomer Mixture of Example 1

The same procedure described in Example 2 was used, except the aryl ether oligomer (87.6 g) was placed in the addition funnel with 584 mL of 1,2-dichloroethane (EDC) to form a solution and the bromine (876 g) was charged to the reaction pot. The aryl ether oligomer/EDC solution was slowly added to the bromine over 1 hour at a temperature range of 40-50° C. The HBr evolved from the reaction was collected in a water trap. The reaction mixture was held at reflux for 4 hr until HBr evolution ceased. The reaction was cooled to 35° C. and the AlCl₃ (8.8 g) catalyst was added. The reaction was brought back to reflux and was held for 3 hours until HBr evolution ceased. After the reaction, a Dean-Stark trap was placed under the condenser and the excess bromine was distilled out with some solvent and additional fresh solvent was added semi-continuously to maintain the reaction volume. After the bromine was removed, hydrazine was added to neutralize any traces of free bromine. The resulting slurry was then pumped into a second reaction flask containing 3L of 2.5% HCl in water at 90° C. The solvent was flashed off, leaving behind a water slurry of the product. The slurry was filtered and the cake was washed with water and dried in an oven to give 305.2 g of product. Analysis: 76.6% organic bromine; 228-362° C. melt range; 164° C. Tg by DSC; 391° C. 5% wt loss by TGA.

### Example 4

### Bromination of Aryl Ether Oligomer Mixture of Example 1

The procedure of Example 2 was followed except EDC was used as the solvent. The flask was charged with 24.2 g aryl ether oligomer and 165 mL EDC with 2.42 g AlCl₃ catalyst. The bromine (242 g) was slowly added over 1 hour at a temperature range of 70-75° C. The HBr evolved from the reaction was collected in a water trap. The reaction mixture was held at 73° C. under total reflux for 2 hours until HBr evolution ceased. The reaction was cooled to 40° C. before a second quantity of catalyst was added to the flask. The reaction was heated back up to reflux (75° C.) and held for 3 hours until HBr evolution ceased a second time. The reaction slurry was pumped into a second reaction flask containing 90° C. 2% HBr in water. The solvent and bromine were flashed off, leaving behind a water slurry of the product. The slurry was filtered and the cake was washed with water and dried in an oven to give 81.9 g of the product. Analysis: 75.1% organic bromine, 208-256° C. melt range; 183° C. Tg by DSC, 375° C. 5% wt loss TGA.

### Example 5

### Bromination of Aryl Ether Oligomer Mixture of Example 1

The procedure of Example 3 was followed with 241 g of bromine and 2.4 g of AlCl₃ charged to the reaction flask. The aryl ether oligomer (24.1 g)/EDC (161 mL) solution was added to the reaction flask from an addition funnel. After the reaction, the slurry was pumped into a second reaction flask containing 90° C. 2% HBr in water. The solvent and bromine were flashed off, leaving behind a water slurry of the product. The slurry was filtered and the cake was washed with water and dried in an oven to give 74.5 g of the product. Analysis: 75.1% organic bromine; 205-252° C. melt range; 178° C. Tg by DSC; 368° C. 5% wt loss by TGA.

### Example 6

### Bromination of Aryl Ether Oligomer Mixture of Example 1

In this example, bromine was used as solvent and reactant. Bromine (612.5 g) was charged to the reaction pot with 0.5 g AlCl₃ and the mixture was heated to 30° C. In a separate addition funnel, the aryl ether oligomer (24.5 g) was charged and held at approximately 80° C. to prevent freezing. The molten oligomer was added to the bromine over 30 minutes at 30-35° C. The reaction mixture was heated to 55° C. and held for approximately 1.5 hr until HBr evolution ceased. The material was cooled to room temperature, charged with 0.5 g additional AlCl₃ catalyst, heated to reflux (55° C.) and held for an additional 2 hr until HBr evolution ceased. After the reaction, the slurry was pumped into a second reaction flask containing 90° C. 2% HCl in water to strip off the excess bromine. The resulting aqueous product slurry was treated with dilute sodium bisulfite to neutralize traces of bromine and then filtered. The filter cake was water-washed and dried to give 80.7 g of product. Analysis: 79.8% organic bromine, 192-260° C. melt range.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A process for producing a flame retardant halogenated aryl ether oligomer composition, the process comprising:
(a) combining an aryl ether oligomer with a liquid carrier having a boiling point lower than water to form a slurry or solution of said aryl ether oligomer in said carrier;
(b) including a halogenating agent in said slurry or solution to form a reaction composition;
(c) reacting said reaction composition at a temperature between about 20° C. and about 80° C. to form a reaction product comprising the desired halogenated aryl ether oligomer;
(d) removing unreacted halogenating agent from the reaction product;
(e) contacting the reaction product with an aqueous medium at an elevated temperature sufficient to drive off the liquid carrier and produce an aqueous slurry of said halogenated aryl ether oligomer; and
(f) recovering the halogenated aryl ether oligomer from said aqueous slurry.

2. The process of claim 1, wherein said aryl ether oligomer comprises repeating monomeric units of the formula (I): 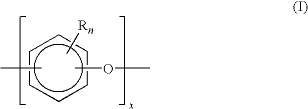
wherein R is alkyl, n is 0 to 3 and x is at least 2.

3. The process of claim 2, wherein x is 3 to 100,000.

4. The process of claim 2, wherein said aryl ether oligomer is produced by reacting a dihaloaryl compound with a diphenolic compound.

5. The process of claim 4, wherein said aryl ether oligomer comprises a mixture of oligomeric compounds having the following formula (II): 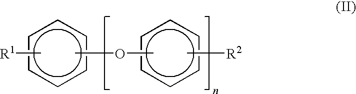
wherein n is 0 or at least 1; where R¹ is H, OH or halogen; and where R² is H, OH, halogen or a phenoxy group of the formula (III): 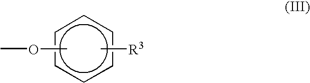
wherein R³ is OH or halogen;
wherein said oligomeric mixture comprises compounds of formula (II) with three benzene rings and compounds of formula (II) with more than three benzene rings;
wherein the average molecular weight of the compounds of formula (II) is at least 400; and
wherein the compounds of formula (II) comprise, on average, from 2 wt % to 35 wt % halogen.

6. The process of claim 5, wherein said oligomeric mixture comprises less than 30 wt % of compounds of formula (II) with two benzene rings and less than 1 wt % of compounds of formula (II) with one benzene ring.

7. The process of claim 5, wherein said oligomeric mixture has a weight average molecular weight (Mw) of about 600 to about 2000 and a polydispersity of about 1.4 to about 2.5 as measured by GPC chromatography versus a polystyrene standard.

8. The process of claim 5, wherein said oligomeric mixture is produced by reacting dibromobenzene with at least one dihydroxybenzene.

9. The process of claim 5, wherein said oligomeric mixture is produced by reacting dibromobenzene with at least one dihydroxybenzene in a molar ratio of dibromobenzene to dihydroxybenzene greater than 1.

10. The process of claim 5, wherein said oligomeric mixture is produced by reacting dibromobenzene with resorcinol.

11. The process of claim 1, wherein said liquid carrier is selected from methylene chloride, chloroform, dibromomethane, 1,2-dichloroethane and bromochloromethane.

12. The process of claim 1, wherein bromine comprises the liquid carrier and the halogenating agent and said contacting (e) removes unreacted halogenating agent from the reaction product.

13. The process of claim 1, wherein the unreacted bromine is removed by a distillation step separate from said contacting (e).

14. The process of claim 1, wherein aqueous medium is water.

15. The process of claim 1, wherein aqueous medium is a dilute acid solution.

16. The process of claim 1, further comprising neutralizing the reaction product with a reducing agent capable of reacting with unreacted halogenating agent.

17. The process of claim 1, wherein (e) is effected by adding water to the reaction product to form an aqueous product mixture and then raising the temperature of said mixture.

18. The process of claim 1, wherein (e) is effected by adding said reaction product to water at a temperature between 70-100° C. to flash off said solvent.

19. The process of claim 1, wherein at least part of said reacting (b) is conducted in the presence of a Lewis acid catalyst.

20. The process of claim 19, wherein said Lewis acid catalyst is aluminum chloride.

21. A flame retardant halogenated aryl ether oligomer composition comprising a mixture of oligomeric compounds having the following formula (IV): 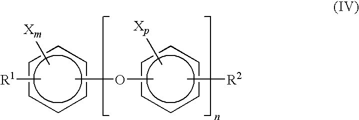
wherein n is 0 or at least 1; where R¹ is H, OH or halogen; X is halogen, each of m and p is at least 1, and where R² is H, OH, halogen or a phenoxy group of the formula (V): 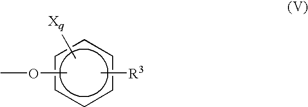
wherein R³ is OH or halogen and q is at least 1;
wherein said oligomeric mixture comprises compounds of formula (IV) with three benzene rings and compounds of formula (IV) with more than three benzene rings;
wherein the average molecular weight of the compounds of formula (IV) is at least 1000; and
wherein the compounds of formula (IV) comprise, on average, from 55 wt % to 82 wt % halogen.

22. A flame retardant polymer composition comprising (i) a flammable macromolecular material and (ii) a flame retardant halogenated aryl ether oligomer composition as claimed in claim 21.

23. The polymer composition of claim 22, wherein the macromolecular material comprises at least one of a polyester, a polyamide and an olefinic resin.
